(19) United States
(12) Patent Application Publication
(10) Pub. No.: US 2020/0186754 A1
(43) Pub. Date: Jun. 11, 2020

(54) SPECTATOR-BASED EVENT SECURITY

(71) Applicant: Xinova, LLC, Seattle, WA (US)

(72) Inventors: Eiji OKI, Tokyo (JP); Naoaki YAMANAKA, Tokyo (JP)

(73) Assignee: Xinova, LLC, Seattle, WA (US)

(21) Appl. No.: 16/619,390

(22) PCT Filed: Jun. 12, 2017
(86) PCT No.: PCT/US17/36974

§ 371 Date: Dec. 4, 2019

(51) Int. Cl. H04N 7/18; H04N 5/247

(52) U.S. Cl. CPC H04N 7/18; H04N 5/247

(57) ABSTRACT

Technologies are generally described for gathering surveillance information from event spectators. In some examples, devices or applications may be provided to spectators of an event. The devices or applications may be configured to gather surveillance information, such as images, video, audio, or location data, and provide the surveillance data to a network server for analysis. Incentives may be provided to spectators in order to encourage use of the devices or applications. Such incentives may include information regarding the event, entry into contests, or the like.

### BACKGROUND

Unless otherwise indicated herein, the materials described in this section are not prior art to the claims in this application and are not admitted to be prior art by inclusion in this section.

Events that draw large numbers of people also often implement surveillance measures to detect and/or prevent certain activities of interest, including criminal activity such as theft. Such surveillance measures may include fixed cameras, microphones, or sensors integrated into the event venue or set up specifically for the event. Security personnel patrolling the venue may also be equipped with cameras, microphones, or other sensors. Surveillance data from these fixed and mobile sensors may then be collected and analyzed to detect potential crimes or crimes in progress.

### SUMMARY

The present disclosure generally describes techniques to provide spectator-based event security.

According to some examples, a method is provided to gather surveillance information from spectators of an event. The method may include receiving a request for information associated with the event from a spectator device, where the spectator device includes a display and at least one sensor, and providing the requested information to the spectator device to be displayed on the display. The method may further include, in conjunction with providing the requested information, gathering the surveillance information associated with the event from the spectator device, where the surveillance information is collected by the at least one sensor, and using the surveillance information to monitor the event.

According to other examples, an application to provide spectator-based event security is provided. The application may include an event information module and a surveillance information module. The event information module may be configured to retrieve information associated with the event and display the retrieved information associated with the event on a display associated with the device. The surveillance information module may be configured to receive surveillance information from a sensor of the device and transmit the surveillance information to a network server in conjunction with the retrieved information associated with the event being displayed by the event information module.

According to further examples, a surveillance system configured to provide spectator-based event security is provided. The surveillance system may include an event-monitoring device configured to collect a first surveillance information regarding the event, an application executed on a device associated with a spectator of the event, and a network server. The application may be configured to receive a request for information associated with the event from the spectator, retrieve the information associated with the event from the network server, display the information associated with the event through a display of the device, and receive a second surveillance information regarding the event from the device. The network server may be configured to retrieve the first surveillance information from the event-monitoring device and the second surveillance information from the application, and combine the first surveillance information and the second surveillance information to monitor the event.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a conceptual illustration of an event surveillance system,

FIG. 2A illustrates how event information may be provided to a spectator device,

FIG. 2B illustrates how event information from different sources may be provided through a surveillance user interface,

FIG. 3 illustrates select components of an example system configured to provide spectator-based event security,

FIG. 4 illustrates a general purpose computing device, which may be used to provide spectator-based event security,

FIG. 5 is a flow diagram illustrating an example method to provide spectator-based event security that may be performed by a computing device such as the computing device in FIG. 4, and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to spectator-based event security.

Briefly stated, technologies are generally described for gathering surveillance information from event spectators. In some examples, devices or applications may be provided to spectators of an event. The devices or applications may be configured to gather surveillance information, such as images, video, audio, or location data, and provide the surveillance data to a network server for analysis. Incentives may be provided to spectators in order to encourage use of the devices or applications. Such incentives may include information regarding the event, entry into contests, or the like.

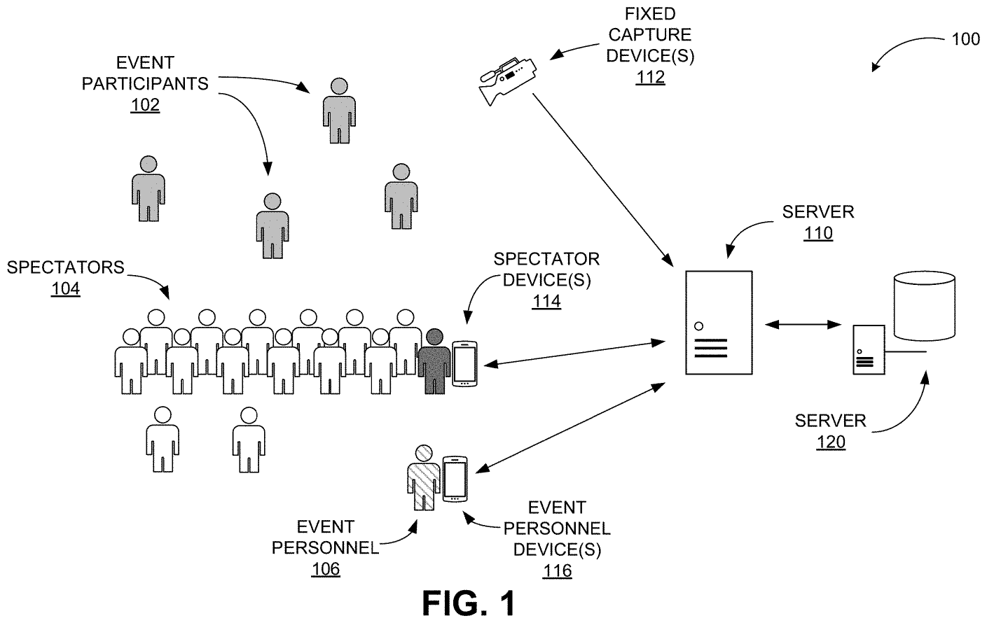

FIG. 1 is a conceptual illustration of an event surveillance system, arranged in accordance with at least some embodiments described herein.

An event surveillance system 100 may be configured to monitor an event having event participants 102 and spectators 104. The event participants 102 may include sports players, speakers, or any other person actually participating in the event, and the spectators 104 may include audience members, fans, or any other person observing the event. In some embodiments, a person may be both an event participant and a spectator. The event may occur in an event venue, and may be, by way of example, a concert, a convention, a conference, a sporting event, or any other event that draws significant numbers of people. The event surveillance system 100 may include a network server 110 configured to control the surveillance system 100. The network server 110 may be configured to communicate with at least one remote server 120, which may in turn be coupled to one or more databases or other remote devices or systems. For example, the remote server 120 may be configured to provide map data associated with the event venue, information regarding the event, information regarding the event participants 102, and/or information regarding the spectators 104. The network server 110 may also be configured to communicate with one or more event personnel 106, for example via event personnel device(s) 116. The event personnel 106 may include security personnel, ticket sellers, customer service representatives, concession personnel, and/or any other relevant personnel associated with the event or event venue but not necessarily participating in the event. In some embodiments, the event personnel 106 may include entities or authorities not necessarily associated with the event or event venue, such as police officers and similar.

The event surveillance system 100 may further include one or more fixed capture devices 112, which may be stationary (for example, affixed or mounted to one or more structures). The fixed capture devices 112 may be configured to capture surveillance data associated with the event and transmit the surveillance data to the network server 110. For example, the fixed capture devices 112 may record still image data, video stream data, audio data, and/or location data associated with the event, the event participants 102, and/or the spectators 104, and may transmit the recorded data to the network server 110. In some embodiments, the event personnel device(s) 116 may also capture surveillance data associated with the event and transmit the surveillance data to the network server 110. Similar to the fixed capture devices 112, the event personnel device(s) 116 may be configured to record still image data, video stream data, audio data, and/or location data associated with the event, the event participants 102, and/or the spectators 104, and to transmit the recorded data to the network server 110. In contrast to the fixed capture devices 112, the event personnel device(s) 116 may be mobile, due to their association with the event personnel 106 who may be moving about the event venue.

While the fixed capture devices 112 and the event personnel devices 116 may provide useful event surveillance data for the event surveillance system 100, in some embodiments the fixed capture devices 112 and the event personnel devices 116 may not be able to provide sufficient coverage of the event or event venue. For example, the fixed capture devices 112 may be stationary, and therefore may be unable to provide sufficiently clear surveillance data of particular areas of interest, which may change over time. Similarly, while the event personnel devices 116 may be mobile due to their association with the event personnel 106, there may be a limited number of the event personnel 106 and therefore of the event personnel devices 116, which may provide insufficient coverage. In addition, the presence of the event personnel 106 may cause individuals engaged in suspicious or criminal activities to temporarily cease activities, which is not necessarily productive in the long term because the individuals may simply resume their activities once the event personnel 106 depart or are no longer present.

Accordingly, in some embodiments, the network server 110 may also be configured to gather surveillance data from one or more spectator devices 114 associated with the spectators 104. For example, the network server 110 may gather recorded still image data, video stream data, audio data, and/or location data associated with the event, the event participants 102, and/or the spectators 104. The location data may include a geographic location (e.g., based on global positioning system “GPS” data), orientation, altitude, and similar information associated with each of the spectator devices 114. The location data may further include information derived from geographical location, orientation, altitude, position, etc. of one or more spectator devices. Such derived information may include position, direction, angle, and estimation of what scene is being captured and may be associated with the captured image or video data (e.g., as metadata) such that the context of the image from which information is acquired and how to manage the location information can be preserved for subsequent searches and analysis. The surveillance data may be gathered by the network server 110 and/or the spectator devices 114 without intervention by the spectators 104 or may be explicitly recorded and/or transmitted to the network server 110 by the spectators 104. In exchange for providing the surveillance data, the server 110 may provide incentives to the spectators 104 via the spectator devices 114. The incentives may include information regarding the event or the event participants 102, coupons for concessions or merchandise purchase, prizes, entries into contests, or any other incentive that would encourage the spectators 104 to provide surveillance data and/or allow surveillance data to be gathered in the background and sent to the network server 110. In some embodiments, the spectator devices 114 may be provided to the spectators 104 by the event organizers or event venue, for free or for a fee. In other embodiments, the spectator devices 114 may belong to the spectators 104, and the network server 110 may provide an application configured to execute on the spectator devices to provide event information and incentives in exchange for gathering surveillance data from the spectator devices 114.

The information request by a spectator to the surveillance system may be linked to an object/image displayed on the spectator's device. Thus, the surveillance system may need to manage the information being requested and the object/image so that they can be retrieved at a later time. As discussed above, location, position, orientation, altitude, and similar information associated with a captured scene (in addition to or in place of similar information associated with a capturing device) may be preserved along with the image or video data. In some examples, such information may be preserved in a standardized format (e.g., predefined portions of metadata or separate defined data) such that this context information is efficiently searchable along with the captured image or video data. For example, if someone is searching for an image of a crowd at a particular location from a particular angle, he/she may search the context data (e.g., metadata) based on their desired parameters and review/analyze images or video that fits their desired parameters. Furthermore, an audience member's behavior may be used to annotate the collected surveillance images or video, to be used for easy retrieval at a later time. For example, in an investigation, a scene where a specific person is shown may be searched efficiently using the annotation or metadata.

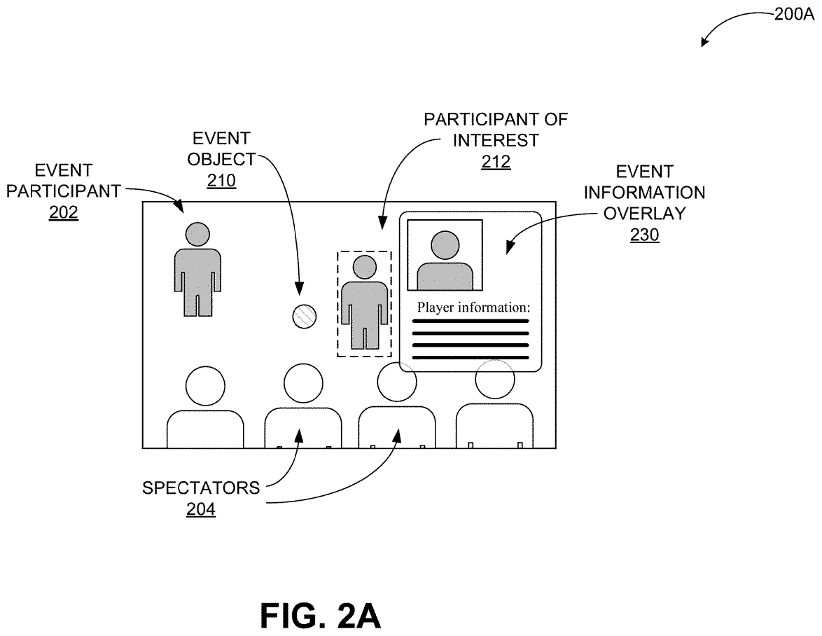

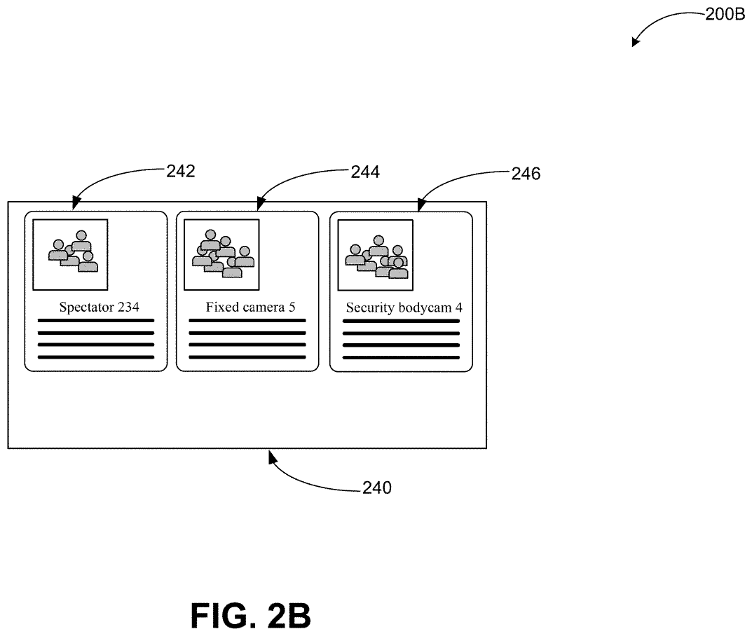

FIG. 2A illustrates how event information may be provided to a spectator device, arranged in accordance with at least some embodiments described herein.

FIG. 2A depicts an augmented-reality view 200A of an event from a spectator's perspective, which may include one or more virtual and/or augmented elements (for example, an event information overlay 230) overlaid over a still image or a real-time video stream. The augmented-reality view 200A may be displayed to a spectator via a display on a spectator device (for example, one of the spectator devices 114 in FIG. 1). In some embodiments, the spectator device may include a smartphone, a tablet, a wearable computer, smart glasses, an augmented reality display device, or any other suitable device.

The augmented-reality view 200A may include views of an event participant 202, one or more spectators 204, an event object 210, such as a ball in a game, and/or an event participant (a participant of interest 212) who may be of interest to the spectator viewing the augmented-reality view 200A. Upon indication by a spectator viewing the augmented-reality view 200A, for example via a spectator-initiated action on a user-interface device, the spectator device providing the augmented-reality view 200A may provide information about the participant of interest 212, the event object 210, and/or the event itself to the spectator, for example via the event information overlay 230.

In some embodiments, event information or incentives may be provided to a spectator without being overlaid on an augmented-reality display. For example, event information or incentives may be provided to a spectator via a text message or other instant message, an email, a voice or audio communication, an image, or any other means of providing information to a spectator via the spectator device.

Spectator devices and/or applications may be configured to provide a variety of event information and incentives to spectators in exchange for surveillance information. For example, the devices and/or applications may have functions for providing information regarding individuals participating in the event (for example, sports players), providing radio or other audio streams of the event, providing video streams of the event, perhaps from different perspectives, providing slow-motion playback of event highlights or particular situations (for example, situations involving questionable calls by referees), providing rules or explanations regarding the event, providing real-time or near-real-time interpretation of event actions or event procedures (for example, plays or referee gestures), highlighting difficult-to-see event objects, such as a baseball or a hockey puck, or any other suitable event information. In some embodiments, some of the event information may be previously recorded for later distribution or processing. For example, potential event actions or procedures, such as plays, referee gestures, and the like may be recorded from previous events and stored on a server, such as the server 110 and/or the remote server 120. The server (or spectator devices) may then compare event actions or procedures captured by spectator devices with the stored actions or procedures to identify the event actions and provide corresponding explanations and information.

For example, assuming that the event is a ball sport, such as soccer, rugby, baseball, or American football, event information may include the location of the ball and/or players and the velocities of the ball and/or players. Taking baseball as a particular example, a spectator device or application executing on a spectator device may display the words “missed swing” or play corresponding audio if a missed swing has occurred. When a referee makes a gesture corresponding to a “strike”, the device and/or application may display the words “strike” or play corresponding audio. When a particular player comes up to bat or to pitch, the device or application may identify the player to the spectator, and may display relevant information, such as statistics or lyrics for a fight song for the player. As another example, if the event is a race such as a marathon, horse race, or bike race, event information may include the identity of participants, statistics for past races, odds, video clips of previous races or highlights, distance markers for the race, and the like.

Incentives may also be provided to spectators in exchange for gathering and/or providing surveillance data. For example, coupons for merchandise or concessions items or discounts may be provided to spectators in exchange for surveillance data. As another example, spectators may be informed of purchasing options for particular types of concession items or merchandise, and may be able to provide their desired brands or types of concession items or merchandise. As yet another example, spectators may be provided with entries into contests for prizes in exchange for uploading particular types of surveillance data. Such surveillance data may include photos having backgrounds that include event participants or other spectators, photos of specific portions of a crowd of spectators, personal information about nearby spectators or acquaintances (for example, names, mailing addresses, electronic addresses, phone numbers, location information, etc.)

FIG. 2B illustrates how event information from different sources may be provided through a surveillance user interface, arranged in accordance with at least some embodiments described herein.

As shown in a diagram 200B, a surveillance user interface 240 may combine views of selected locations at an event from different sources. For example, a still image or video provided by a spectator device may be correlated with images or videos of fixed cameras and/or security personnel devices based on location information (geographical location, orientation, etc.) received from the spectator device. Thus, the different views may be of the same location at the event (e.g., same group of people or point of interest) with some difference due to exact locations and orientations of the source devices. In the example surveillance user interface 240, a spectator view 242, a fixed camera view 244, and a security personal view 246 are displayed. In other embodiments, additional or fewer views may be displayed. Moreover, additional information such as identification of the source, location information, and any other pertinent/ captured information may be displayed along with the image/video from each source.

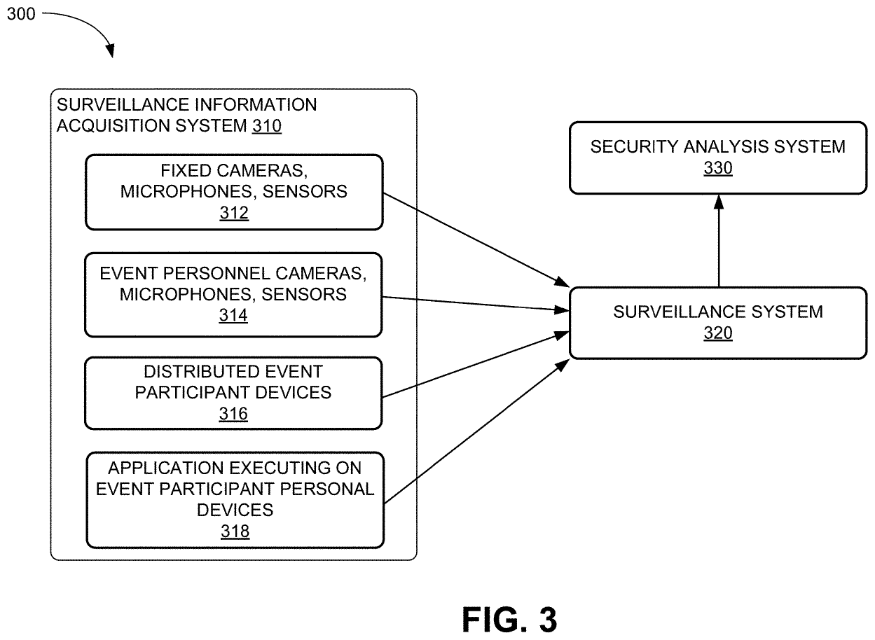

FIG. 3 illustrates select components of an example system configured to provide spectator-based event security, arranged in accordance with at least some embodiments described herein.

A system 300 configured to provide spectator-based event security may include a surveillance information acquisition system 310, which in turn may include fixed cameras, microphones, and sensors 312 (similar to the fixed capture devices 112 in FIG. 1), event personnel cameras, microphones, and sensors 314 (similar to the event personnel device(s) 116 in FIG. 1), event participant devices 316 distributed by event organizers or the event venue to event spectators or participants, and an application 318 configured to execute on event participant or spectator personal devices, as described above. Each of the components of the surveillance information acquisition system 310 may then provide surveillance information such as still images, video streams, audio streams, location data, and/or other relevant data to a surveillance system 320. The surveillance system 320, in turn, may combine the surveillance data provided by the components of the surveillance information acquisition system 310 and provide the combined surveillance data to a security analysis system 330. The security analysis system 330 may then analyze the combined surveillance data to identify abnormal or suspicious individuals or behaviors.

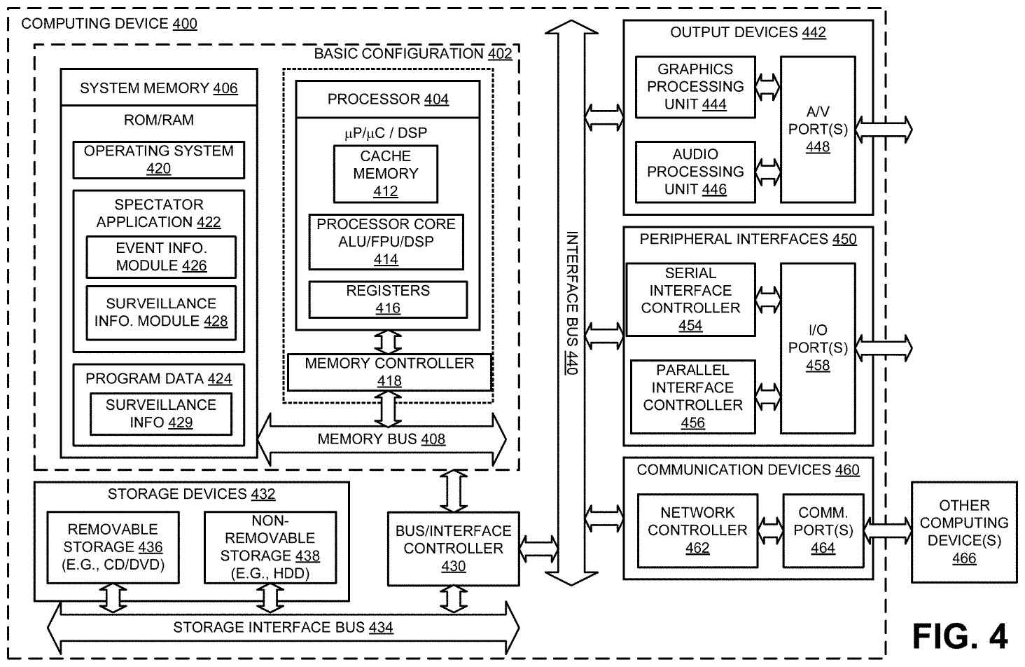

FIG. 4 illustrates a general purpose computing device, which may be used to provide spectator-based event security, arranged in accordance with at least some embodiments described herein.

For example, the computing device 400 may be used to provide spectator-requested event information and surveillance information as described herein. In an example basic configuration 402, the computing device 400 may include one or more processors 404 and a system memory 406. A memory bus 408 may be used to communicate between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (μC), a digital signal processor (DSP), or any combination thereof. The processor 404 may include one or more levels of caching, such as a cache memory 412, a processor core 414, and registers 416. The example processor core 414 may include an arithmetic logic unit (ALU), a floating point unit (FPU), a digital signal processing core (DSP Core), or any combination thereof. An example memory controller 418 may also be used with the processor 404, or in some implementations, the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, a spectator application 422, and program data 424. The spectator application 422 may include an event information module 426 configured to retrieve and provide event information and a surveillance information module 428 configured to gather and transmit surveillance information as described herein. The program data 424 may include, among other data, surveillance information 429 or the like, as described herein.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more data storage devices 432 via a storage interface bus 434. The data storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDD), optical disk drives such as compact disc (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD-ROM, digital versatile disks (DVD), solid state drives (SSD), or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., one or more output devices 442, one or more peripheral interfaces 450, and one or more communication devices 460) to the basic configuration 402 via the bus/interface controller 430. Some of the example output devices 442 include a graphics processing unit 444 and an audio processing unit 446, which may be configured to communicate to various external devices such as a display or speakers via one or more A/V ports 448. One or more example peripheral interfaces 450 may include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 460 includes a network controller 462, which may be arranged to facilitate communications with one or more other computing devices 466 over a network communication link via one or more communication ports 464. The one or more other computing devices 466 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a part of a general purpose or specialized server, mainframe, or similar computer that includes any of the above functions. The computing device 400 may also be implemented as a personal computer including both laptop computer and non-laptop computer configurations.

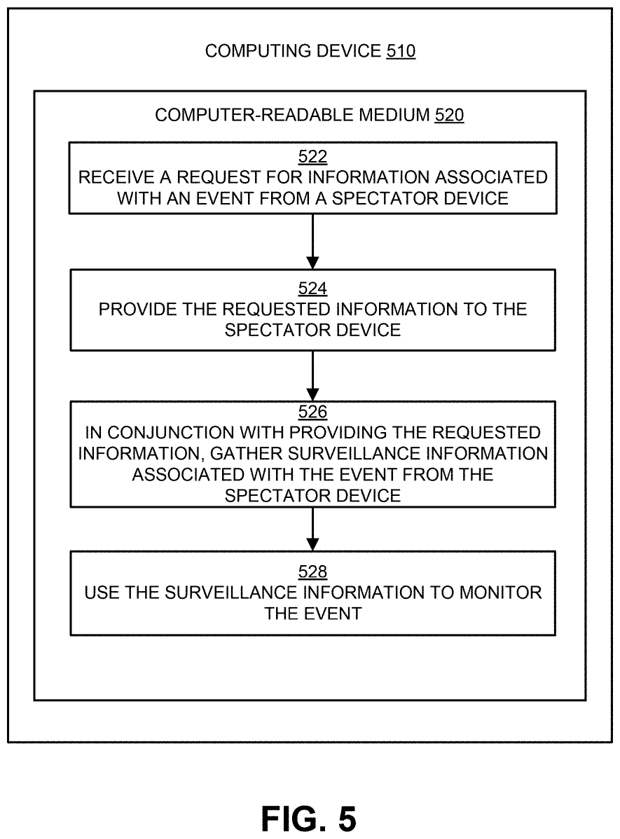

FIG. 5 is a flow diagram illustrating an example method to provide spectator-based event security that may be performed by a computing device such as the computing device in FIG. 4, arranged in accordance with at least some embodiments described herein.

Example methods may include one or more operations, functions or actions as illustrated by one or more of blocks 522, 524, 526, and/or 528, and may in some embodiments be performed by a computing device such as the computing device 500 in FIG. 5. The operations described in the blocks 522-528 may also be stored as computer-executable instructions in a computer-readable medium such as a computer-readable medium 520 of a computing device 510.

An example process to provide spectator-based event security may begin with block 522, “RECEIVE A REQUEST FOR INFORMATION ASSOCIATED WITH AN EVENT FROM A SPECTATOR DEVICE”, where a server (for example, the server 110) may receive a request for event information from a device (for example, the spectator device(s) 114) associated with a spectator. The event information, as described above, may be related to participants and/or actions associated with the event.

Block 522 may be followed by block 524, “PROVIDE THE REQUESTED INFORMATION TO THE SPECTATOR DEVICE”, where the server may provide the requested information to the spectator device. For example, the server may provide the information as data suitable for display on an augmented-reality display device. In some embodiments, the provided information may include information about a contest or incentive for the spectator, as described above.

Block 524 may be followed by block 526, “IN CONJUNCTION WITH PROVIDING THE REQUESTED INFORMATION, GATHER SURVEILLANCE INFORMATION ASSOCIATED WITH THE EVENT FROM THE SPECTATOR DEVICE”, where the server may receive surveillance information, such as still images, video streams, audio streams, location data, and/or other suitable information, from the spectator device. The spectator device may send the surveillance information in the background, without specific instructions from the spectator, or may send the surveillance information in response to an action by the spectator, as described above.

Block 526 may be followed by block 528, “USE THE SURVEILLANCE INFORMATION TO MONITOR THE EVENT”, where the server may use the surveillance information gathered from the spectator device, along with other surveillance information from other sources (for example, fixed surveillance devices or surveillance devices associated with event personnel) to monitor the event and identify abnormal or suspicious individuals or behaviors.

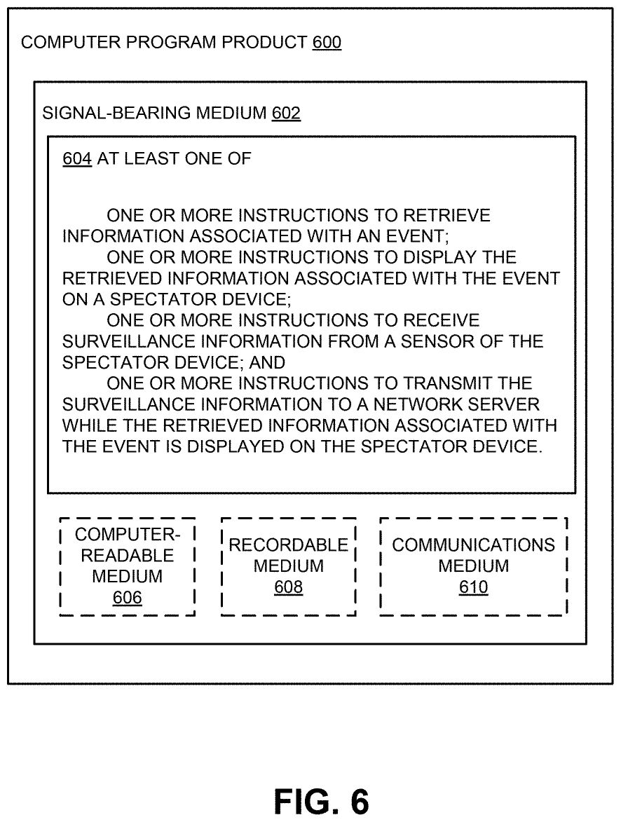

FIG. 6 illustrates a block diagram of an example computer program product, arranged in accordance with at least some embodiments described herein.

In some examples, as shown in FIG. 6, a computer program product 600 may include a signal-bearing medium 602 that may also include one or more machine-readable instructions 604 that, when executed by, for example, a processor may provide the functionality described herein. Thus, for example, referring to the processor 404 in FIG. 4, the spectator application 422 may undertake one or more of the tasks shown in FIG. 6 in response to the instructions 604 conveyed to the processor 404 by the signal-bearing medium 602 to perform actions associated with providing spectator-based event security as described herein. Some of those instructions may include, for example, instructions to retrieve information associated with an event, display the retrieved information associated with the event on a spectator device, receive surveillance information from a sensor of the spectator device, and/or transmit the surveillance information to a network server while the retrieved information associated with the event is displayed on the spectator device, according to some embodiments described herein.

In some implementations, the signal-bearing medium 602 depicted in FIG. 6 may encompass computer-readable medium 606, such as, but not limited to, a hard disk drive (HDD), a solid state drive (SSD), a compact disc (CD), a digital versatile disk (DVD), a digital tape, memory, etc. In some implementations, the signal-bearing medium 602 may encompass recordable medium 608, such as, but not limited to, memory, read/write (R/W) CDs, R/W DVDs, etc. In some implementations, the signal-bearing medium 602 may encompass communications medium 610, such as, but not limited to, a digital and/or an analog communication medium (e.g., a fiber optic cable, a waveguide, a wired communication link, a wireless communication link, etc.). Thus, for example, the computer program product 600 may be conveyed to one or more modules of the processor 404 by an RF signal bearing medium, where the signal-bearing medium 602 is conveyed by the wireless communications medium 610 (e.g., a wireless communications medium conforming with the IEEE 802.11 standard).

According to some examples, a method is provided to gather surveillance information from spectators of an event. The method may include receiving a request for information associated with the event from a spectator device, where the spectator device includes a display and at least one sensor, and providing the requested information to the spectator device to be displayed on the display. The method may further include, in conjunction with providing the requested information, gathering the surveillance information associated with the event from the spectator device, where the surveillance information is collected by the at least one sensor, and using the surveillance information to monitor the event.

According to some embodiments, the requested information associated with the event may include information about individuals associated with the event, actions occurring in the event, procedures associated with the event, purchasing options associated with the event, and/or a video stream of the event from a different perspective. The spectator device may include a smartphone, a tablet, a wearable computer, smart glasses, and/or an augmented reality display device. The surveillance information may include a still image, a video stream, an audio stream, and/or location information associated with the spectator device. The method may further include combining the surveillance information with other information from a fixed camera and/or a security personnel camera. In some embodiments, the method may further include providing an incentive to the spectator in exchange for gathering the surveillance information. The method may further include providing an application to the spectator device, where the application is configured to receive the request for information, provide the requested information associated with the event, and/or gather the surveillance information.

According to other examples, an application to provide spectator-based event security is provided. The application may include an event information module and a surveillance information module. The event information module may be configured to retrieve information associated with the event and display the retrieved information associated with the event on a display associated with the device. The surveillance information module may be configured to receive surveillance information from a sensor of the device and transmit the surveillance to a network server in conjunction with the retrieved information associated with the event being displayed by the event information module.

According to some embodiments, the requested information associated with the event may include information about individuals associated with the event, actions occurring in the event, procedures associated with the event, purchasing options associated with the event, and/or a video stream of the event from a different perspective. The device may include a smartphone, a tablet, a wearable computer, smart glasses, and/or an augmented reality display device. The sensor may include a camera, a microphone, a locator module, and/or a network interface. The surveillance information may include a still image, a video stream, an audio stream, and/or location information associated with the device. The information associated with the event may include information about at least one contest, and the event information module may be further configured to determine that the surveillance information module has transmitted the surveillance information and provide one or more contest entries to the spectator in response to determination that the surveillance information has been transmitted.

According to further examples, a surveillance system configured to provide spectator-based event security is provided. The surveillance system may include an event-monitoring device configured to collect a first surveillance information regarding the event, an application executed on a device associated with a spectator of the event, and a network server. The application may be configured to receive a request for information associated with the event from the spectator, retrieve the information associated with the event from the network server, display the information associated with the event through a display of the device, and receive a second surveillance information regarding the event from the device. The network server may be configured to retrieve the first surveillance information from the event-monitoring device and the second surveillance information from the application, and combine the first surveillance information and the second surveillance information to monitor the event.

According to some embodiments, the event-monitoring device may include a fixed camera and/or a security personnel camera. The device associated with the spectator may include a smartphone, a tablet, a wearable computer, smart glasses, and/or an augmented reality display device. The requested information associated with the event may include information about individuals associated with the event, actions occurring in the event, procedures associated with the event, purchasing options associated with the event, and/or a video stream of the event from a different perspective. The first surveillance information and the second surveillance information may include a still image, a video stream, an audio stream, and/or location information associated with the event-monitoring device and/or the device associated with the spectator. The second surveillance information may also include personal information associated with at least one other spectator of the event. In some embodiments, the application may be further configured to provide an incentive to the spectator in exchange for gathering the second surveillance information. The network server may be configured to provide the application to the device.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to gather surveillance information from spectators of an event, the method comprising:
receiving a request, at a server, for information associated with the event from a spectator device, wherein the spectator device includes a display and at least one sensor;
providing the requested information to the spectator device to be displayed on the display;
in conjunction with the requested information, receiving the surveillance information associated with the event from the spectator device, wherein the surveillance information is collected by the at least one sensor of the spectator device; and
using the surveillance information to monitor the event.

2. The method of claim 1, wherein the requested information associated with the event includes at least one of information about individuals associated with the event, actions occurring in the event, procedures associated with the event, or purchasing options associated with the event.

3. The method of claim 1, wherein the requested information associated with the event includes a video stream of the event from a different perspective from that of the spectator device.

4. The method of claim 1, wherein the spectator device includes one or more of a smartphone, a tablet, a wearable computer, smart glasses, or an augmented reality display device.

5. The method of claim 1, wherein the surveillance information includes at least one of a still image, a video stream, an audio stream, or location information associated with the spectator device.

6. The method of claim 5, wherein the location information includes at least one of geographic location information, orientation information, and altitude information.

7. The method of claim 1, further comprising combining the surveillance information with other information from at least one of a fixed camera or a security personnel camera.

8. The method of claim 1, further comprising providing an incentive to the spectator in exchange for the surveillance information.

9. The method of claim 1, further comprising providing an application to the spectator device, the application configured to one or more of receive the request for information, provide the requested information associated with the event, and gather the surveillance information.

10. An application configured to be executed on a device associated with a spectator of an event, the application comprising:
an event information module configured to:
retrieve information associated with the event; and
display the retrieved information associated with the event on a display associated with the device; and
a surveillance information module configured to:
receive surveillance information captured by a sensor of the device; and
transmit the surveillance information to a network server in conjunction with the retrieved information associated with the event being displayed by the event information module.

11. The application of claim 10, wherein the information associated with the event includes at least one of information about individuals associated with the event, actions occurring in the event, procedures associated with the event, purchasing options associated with the event, or a video stream of the event from a different perspective from that of the device.

12. The application of claim 10, wherein the device includes one or more of a smartphone, a tablet, a wearable computer, smart glasses, or an augmented reality display device.

13. The application of claim 10, wherein:
the sensor includes one of a camera, a microphone, a locator module, and a network interface; and
the surveillance information includes at least one of a still image, a video stream, an audio stream, or location information associated with the device.

14. The application of claim 10, wherein the information associated with the event includes information about at least one contest, and the event information module is further configured to:
determine that the surveillance information module has transmitted the surveillance information; and
provide at least one contest entry to the spectator in response to determination that the surveillance information has been transmitted.

15. A surveillance system configured to monitor an event, the system comprising:
an event-monitoring device configured to collect a first surveillance information regarding the event;
an application executed on a device associated with a spectator of the event and configured to:
receive a request for information associated with the event from the spectator;
retrieve the information associated with the event from a network server;
display the information associated with the event through a display of the device; and
receive a second surveillance information regarding the event from the device captured by one or more sensors of the device; and
a network server configured to:
retrieve the first surveillance information from the event-monitoring device and the second surveillance information from the application; and
combine the first surveillance information and the second surveillance information to monitor the event.

16. The surveillance system of claim 15, wherein the event-monitoring device comprises one of a fixed camera and a security personnel camera.

17. The surveillance system of claim 15, wherein the device associated with the spectator includes one of a smartphone, a tablet, a wearable computer, smart glasses, and an augmented reality display device.

18. The surveillance system of claim 15, wherein the requested information associated with the event includes at least one of information about individuals associated with the event, actions occurring in the event, procedures associated with the event, purchasing options associated with the event, or a video stream of the event from a different perspective from that of the device associated with the spectator.

19. The surveillance system of claim 15, wherein the first surveillance information and the second surveillance information include one or more of a still image, a video stream, an audio stream, and location information associated with at least one of the event-monitoring device or the device associated with the spectator.

20. The surveillance system of claim 19, wherein the location information includes at least one of geographic location information, orientation information, and altitude information.

21. The surveillance system of claim 15, wherein the second surveillance information includes personal information associated with at least one other spectator of the event.

22. The surveillance system of claim 15, wherein the application is further configured to provide an incentive to the spectator in exchange for gathering the second surveillance information.

23. The surveillance system of claim 15, wherein the network server is configured to provide the application to the device.
